(19) United States
(12) Patent Application Publication
(10) Pub. No.: US 2003/0236889 A1
(43) Pub. Date: Dec. 25, 2003

(54) Data projection system and method

(75) Inventors: Todd R. Manion, Bellevue, WA (US); Robert D. Donner, Sammamish, WA (US); Kenneth G. Richards, Renton, WA (US); Michael E. Shappell, Issaquah, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/179,431

(22) Filed: Jun. 25, 2002

(51) Int. Cl. G06F 15/16

(52) U.S. Cl. 709/227

(57) ABSTRACT

An improved information presentation system and method enable the automatic connection of a presenter's device to a projection screen or other projection target. The system and method allow device discovery and session establishment with minimal effort on the part of the presenter. In an embodiment of the invention, a reverse terminal server model is utilized to establish a connection from a presentation server, or projection device, to a presentation client, or projection target. The discovery by the projection device of the projection target is by way of the Universal Plug and Play protocol, whereas exchange of data to be exhibited or manifested is by way of a terminal services session commenced via a reverse terminal server model. With respect to visual materials, shadowing may be used to provide the display on the terminal services server host while the terminal services client host renders the information for presentation.

### TECHNICAL FIELD

This invention relates generally to the technology of information sharing and, more particularly, relates to a system and method for simplified information projection to a projector or other device or devices.

### BACKGROUND OF THE INVENTION

Despite the technological advances realized in recent years, many traditional business activities still have a prominent place in today's workplaces. One such activity is the meeting or conference. Often, such a collaborative effort will involve a presentation of material by one participant to a number of other participants. Traditional means for presenting information include projection on a screen, display on a monitor or other optically active device, or presentation in hard copy form, such as on a white board, chalkboard or easel. While each of these methods has benefits and drawbacks in terms of cost, complexity, and effectiveness, projection and display are typically best suited for rapidly changing data such as may be presented via slides or video. Additionally, projection and display are also ideal for sharing of information from the screen of a computer or other computing device, such as during a MICROSOFT brand POWER POINT slide presentation.

Unfortunately for projection technology users and participants, traditional mechanisms for projection and display of information from a computing device, while highly effective once initiated, have often been complex to establish, requiring the connection of cords, such as VGA cables, and the setting of various parameters. This complexity can lead to complications before and during a presentation, and often lead to delay in commencing a presentation. Additionally, such mechanisms do not allow simple and rapid transfer of control of the presentation from one speaker to another. Thus, for example, if a first speaker is using a PC to present a POWER POINT slide show and wishes to cede the floor to a second speaker, the second speaker typically must physically leave their chair and walk to a location next to the first speaker's PC, during which time there will be discontinuity, delay, and distraction for the other participants.

A system and method of conferencing presentation are needed whereby set up of a conferencing presentation is simplified and whereby control and transfer of presentation management can occur with decreased complexity and improved speed.

### SUMMARY OF THE INVENTION

A novel system and method are described for increasing the effectiveness and simplicity of information projection. The scenarios enabled involve the automatic connection of a presenter's device to a projection screen or other projection target. Rather than being required to find and connect various wires and cables in order to make a presentation, the presenter simply walks into a room, whereupon his or her laptop computer or other device discovers and connects to the desired projection target, such as a conference room projector, with minimal effort on the part of the presenter.

In an embodiment of the invention, a reverse terminal server model is utilized to establish a connection from a presentation server, or projection device, to a presentation client, or projection target. The discovery by the projection device of the projection target is by way of the Universal Plug and Play protocol. Once discovery has been accomplished, a terminal services session is commenced via the reverse terminal server model to enable the exchange of screen data and/or other data between the projection device and the projection target. In an embodiment, shadowing is used to provide the display on the terminal services server while the terminal services client renders the information for presentation.

Other features and advantages of various embodiments of the invention will become apparent from the detailed description set forth hereinafter.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram generally illustrating an exemplary computer system usable in an implementation of an embodiment of the invention;

FIGS. 2A and 2B are schematic diagrams showing alternative architectures of a network system within which an embodiment of the invention may be implemented, including multiple computers comprising a projecting computer and multiple projection target computers, as well as an electronic conference room display screen or projector;

FIG. 3 is a schematic diagram illustrating in greater detail the placement and interconnectivity of projection application program components and related components in an embodiment of the invention; and

FIG. 4 is a flow chart describing the steps taken in an embodiment of the invention to initiate a projection session between a projecting device and a projection target device.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention is primarily for use in a networked environment and may further be practiced in distributed computing environments where tasks are performed by remote processing devices that are linked through a communications network. In a distributed computing environment, program modules may be located in both local and remote memory storage devices.

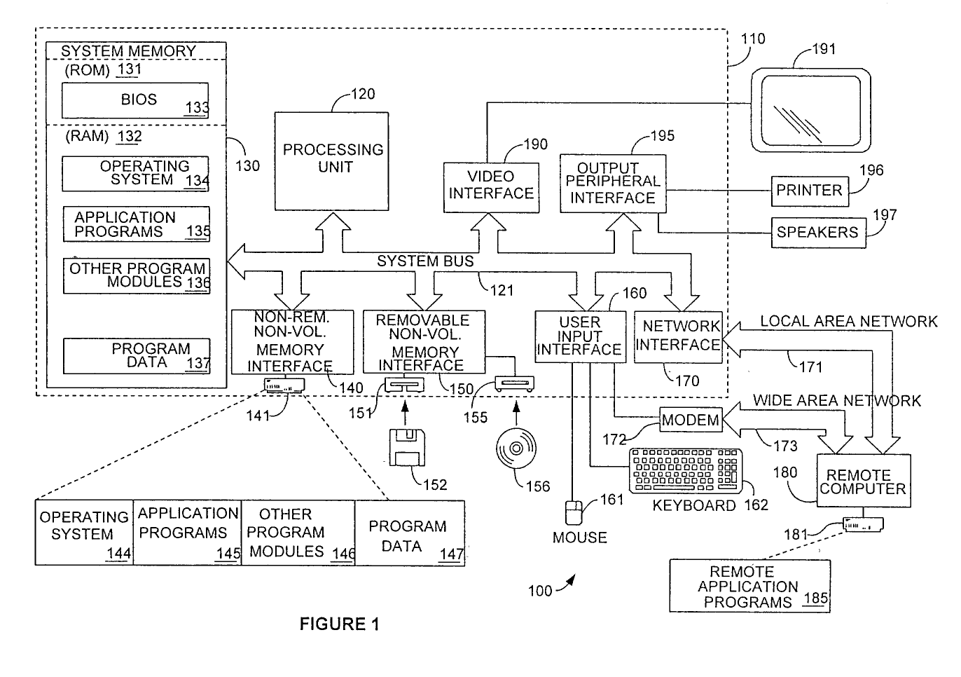

FIG. 1 illustrates an example of a suitable computing system environment 100 usable in an implementation of the invention, and according to which either or both of a projection device and a projection target device may operate. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100. Furthermore, note that the term “projector” includes, but is not limited to, any group display mechanism with wireless capability. It is not required that the projector comprise a wireless interface, since, for example, in some embodiments of the invention the projector may be physically wired to an infrastructure.

The invention may be implemented by way of numerous other general purpose or special purpose computing system environments or configurations. Examples of well known computing systems, environments, and/or configurations that are suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

An exemplary system for implementing the invention includes a general-purpose computing device in the form of a computer 110. Components of the computer 110 generally include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example only, and not limitation, such architectures include Industry Standard Architecture (ISA) bus, Micro Channel Architecture (MCA) bus, Enhanced ISA (EISA) bus, Video Electronics Standards Associate (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example only, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110.

Communication media typically embodies computer readable instructions, data structures, program modules or other data in a modulated data signal such as a carrier wave or other transport mechanism and includes any information delivery media. The term “modulated data signal” means a signal that has one or more of its characteristics (such as, for example, voltage or current level, voltage or current pulse existence or nonexistence, voltage or current pulse width, voltage or current pulse spacing, etc.) set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates RAM 132 as containing operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components caneither be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a keyboard 162, pointing device 161 (commonly referred to as a mouse), and trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A dedicated monitor 191 or other type of display device may also be connected to the system bus 121 via an interface, such as a video interface 190. In addition to the monitor, computer 110 may also include other peripheral output devices such as speakers 197 and printer 196, which may be connected through an output peripheral interface 195.

In the implementation of an embodiment of the invention, the computer 110 operates in a networked environment using logical connections to one or more remote computers, such as a remote computer 180. The remote computer 180 may be a personal computer, a router, a network PC, a peer device or other common network node, or a dedicated projection target device such as an electronic projection screen or monitor, and in any case the remote computer or computers typically include many or all of the elements described above relative to the personal computer 110, although only a memory storage device 181 has been illustrated in FIG. 1, and although in some cases the remote computer can lack much of the functionality contained in the computer 110. The logical connections depicted in FIG. 1 include a local area network (LAN) 171 and a wide area network (WAN) 173, but the computer 110 may additionally or alternatively use one or more other networking environments. For example, the computer 110 may reside on an ad hoc network via a communications interface such as a wireless interface. Networking environments of all types are commonplace in offices, enterprise-wide computer networks, intranets and the Internet.

The computer 110 should include facilities for accessing the networks to which it is attachable. For example, when used in a LAN networking environment, the personal computer 110 is connected to the LAN 171 through a network interface or adapter 170. Another node on the LAN, such as a proxy server, may be further connected to a WAN such as the Internet. When used in a WAN networking environment, the computer 110 typically includes a modem 172 or other means for establishing communications directly or indirectly over the WAN 173, such as the Internet. The modem 172, which may be internal or external, may be connected to the system bus 121 via the user input interface 160, or other appropriate mechanism. Typically, wireless network interfacing, be it to a LAN, WAN, ad hoc network, or other network type, will allow the greatest freedom to reap the benefits of the invention, although the invention also contemplates the use of more traditional hard wired interfaces.

In a networked environment, program modules depicted relative to the personal computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used. It is not intended to limit the invention to use in a permanent network infrastructure, since it may also be used in transiently connected environments, such as for example a wholly or partially wireless network environment interconnected wholly or partially via optical, infrared, and/or radio frequency wireless connections.

Herein, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

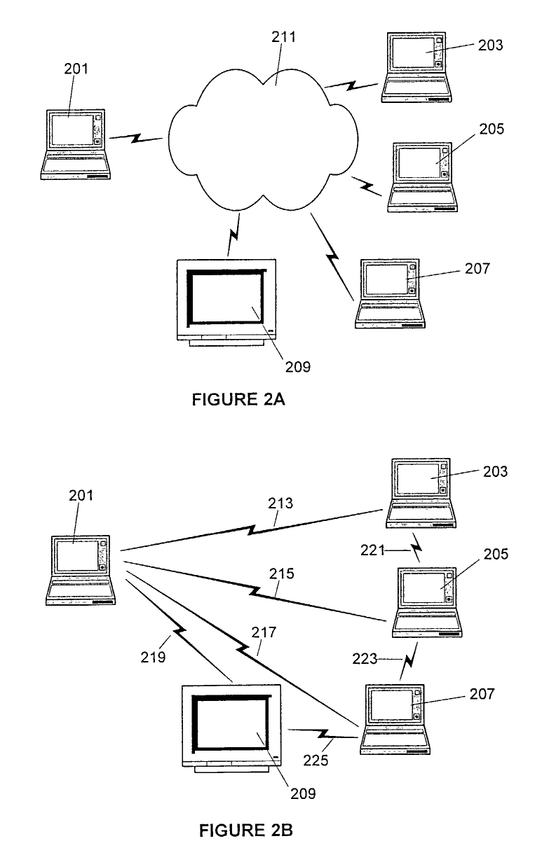

FIG. 2A illustrates schematically a networking environment within which the present invention may be implemented. In particular, the network environment shown in the figure includes a projection device 201, which may be any computing device such as, for example, those described above in reference to FIG. 1, for projecting information to one or more projection target devices 203, 205, 207, and 209. Projection target devices 203-207 are illustrated as non-dedicated computing devices similar to the projection device 201. In this case, for example, the devices 201-207 may be, by way of example and not limitation, laptop computers, desktop computers, handheld computing devices, any other multi-purpose computing devices, or any combination of these types of devices. A projection target device need not be a traditional computing device, and may be for example a television system. Network 211 is usable to transfer information between the target devices 203-207 and the projection device 201.

Similarly, the projection targets may additionally or alternatively include a dedicated projection device such as an electronic conference room projector or display device 209. As with the other projection targets 203-207, the target device 209 preferably communicates with the projection device 201 via network 211. Network 211 may be any type of network, but will typically comprise wireless interfaces between the projecting device 201 and the network 211, and between the network 211 and the projection targets 203-207. Furthermore, the interface between the network 211 and the dedicated projection device 209 may desirably be either wired or wireless. For example, since the dedicated projection device 209 can remain in a particular location, such as a conference room, for a long period of time, there is no significant decrease in device utility by having a wired interface from the device 209 to the network 211. The network 211 itself will generally, although not necessarily, be a wired infrastructure such as a corporate LAN, a WAN, or other traditional wholly or partially wired network.

An alternative network environment is shown schematically in FIG. 2B. In particular, projection device 201 and projection targets 203-209 are interconnected via an ad hoc wireless network consisting of wireless links 213-225. Note that not all of connections 213-225 are necessary since an ad hoc network does not require direct connection of every node to every other node. For example, a node may be connected to all nodes of the ad hoc network indirectly via a single connection to another node. Thus, ad hoc topologies include rings, lines, webs, hub-and-spokes, and/or other topologies as needed. Often, the physical distance of a particular device from other devices will determine to which device or devices, if any, of the ad hoc network the particular device connects directly.

The usage and interaction scenarios of the aforementioned components will be described briefly hereinafter before proceeding to a detailed description of the interaction mechanics. The projection device 201 is in the possession of a presenting individual wishing to project material of interest to receiving individuals, typically in a conference room or meeting room setting, although the inventive system is also usable in nonbusiness settings, such as in a home environment, as well. The material of interest may be graphical, such as images or video, or textual such as in a document, chart etc., and may also include audio elements. In an embodiment of the invention, the material of interest is entirely audio information. Although the material of interest need not be computer-generated, it is preferably accessible to the projection device 201 locally or remotely in a computer-readable format. The projection target devices 203-207 may be the laptop computers of the receiving individuals, while the projection target device 209 may be a dedicated projection system, such as a conference room projector or large screen monitor or other display not typically associated physically with any one user, unlike a mobile laptop or handheld device.

The network connectivity between the devices 203-209 typically commences as each device comes into communication range of the projection device 201 associated with the presenting user. Thus for example, assume that the dedicated device 209 resides permanently in a conference room. When the presenting user enters the conference room with the projection device 201, a wireless connection, either ad hoc or via a network infrastructure, is formed between the dedicated device 209 and the projection device 201. The presenting user is then able to project material from his device 201 onto the screen of the dedicated device 209 for the receiving individuals to observe. In this manner, the presenting user has effected a presentation without physically connecting any cables or cords, and can similarly end the presentation, or transfer its control to another presenting individual using another projection device, without disconnecting any cables or cords.

In much the same way, the presenting user can present material of interest to a number of target devices such as devices 203-207. For example, the network connection between the projection device 201 and the target devices 203-207 is automatically executed after automated discovery without requiring the user to locate and manipulate physical connections. In this case, the presentation of material occurs from the projection device 201 to the screens of the target devices, which may be laptop computers belonging to receiving individuals.

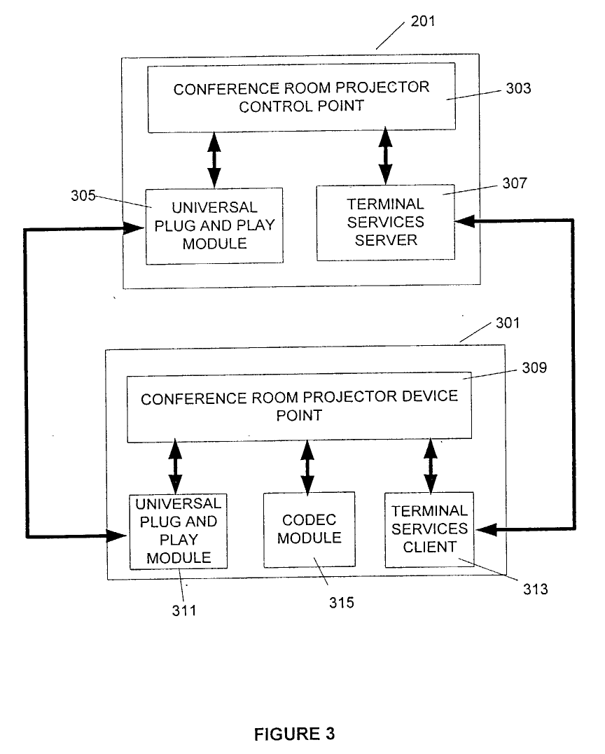

Specific exemplary architectures of the projection device 201 and a projection target 301 are illustrated in greater detail schematically in FIG. 3. Although only one projection target is illustrated in FIG. 3, it will be appreciated that the invention contemplates the use of multiple and varied such devices as well, as illustrated by way of FIG. 2. It can be seen that the projection device 201 architecture comprises a projector control point 303, a Universal Plug and Play component 305, and a terminal services server 307. The projector control point 303 is an application that controls the function of the Universal Plug and Play component 305 and the terminal services server 307 to establish and maintain a projection session. The projector control point 303 is also responsible for presentation of user interface information to the presenting individual via a display of the device 201. Such user interface information preferably comprises a selection window within which the presenting user may view available projection targets and select desired connection targets. Other connection information such as time, status, control change requests and so forth may also be presented in the user interface by the projector control point 303.

Similarly, the projection target 301 architecture comprises a projector device point 309, a Universal Plug and Play component 311, and a terminal services client 313. As with the projection device 201 architecture, the projector device point 309 is an application that controls the Universal Plug and Play component 311 and the terminal services client 313 during the set up and utilization of a projection session. The Universal Plug and Play component 311 of the projection target 301 cooperates with the Universal Plug and Play component 305 of the projection device 201 to facilitate discovery by the projection device 201 of the projection target 301 in an embodiment of the invention as will be described hereinafter. In a similar manner, the terminal services client 313 of the projection target 301 cooperates with the terminal services server 307 of the projection device 201 during the projection session to facilitate the exchange of presentation information from the projection device 201 to the projection target 301, as will be described hereinafter in greater detail.

Although not explicitly shown, each of the projection device 201 and the projection target 301 preferably also includes an operating system for controlling the basic operation of the relevant device. Although there is no limitation within the invention as to suitable operating systems, it has been observed that the XP brand operating system and the WINDOWS CE brand operating system, both by MICROSOFT of Redmond, Wash., are ideally suited for use within the invention. In particular, the projection target 301 can advantageously use the WINDOWS CE brand operating system since the projection target 301 may have both limited computation demands and limited computational resources.

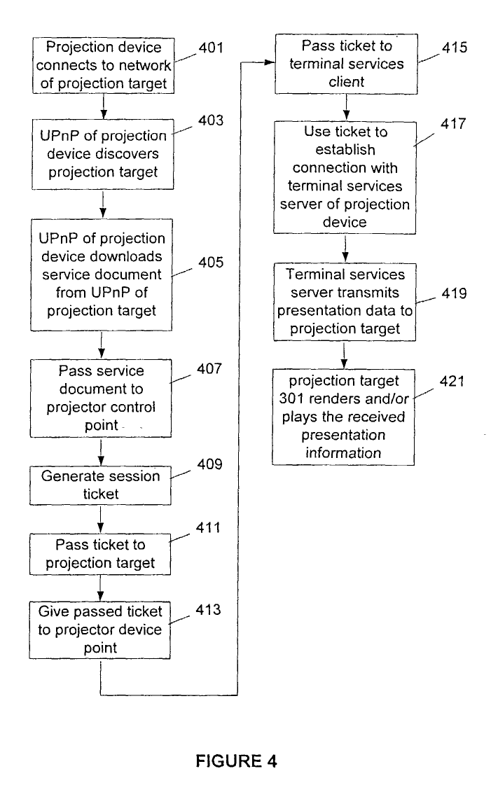

Note that the projection target 301 architecture also comprises a codec module 315 in an embodiment of the invention. The codec module 315 is used to interpret or decode information received by the projection target 301 from the projection device 201 when the received information comprises encoded audio or video information, as will be described in greater detail below with respect to FIG. 4. Note that multiple and/or diverse codecs may be used without limitation.

FIG. 4 illustrates in flow chart form the operation of the aforementioned system components during establishment of a projection session, and while the projection session continues in progress. Before a projection session can begin, a connection should be formed between the projection device 201 and the projection target 301 to the extent such a connection is not already open. Thus, at step 401, the projection device 201 forms a connection via an appropriate network interface to the network upon which the projection target 301 resides. If the projection target 201 has not yet connected to the relevant network then it too should connect at this time via an appropriate network interface. In an embodiment of the invention, the network comprises an 802.11 compliant wireless link, operated either in infrastructure mode or as part of an ad hoc network as discussed above.

At this point, the projection device 201 and the projection target 301 are both connected to a common network. Still, each of the projection device 201 and the projection target 301 may remain unaware of the presence of the other as such. If so, then at step 403 the Universal Plug and Play component 305 of the projection device is apprised of the presence of the Universal Plug and Play component 311 of the projection target 301. This step may be carried out either via the standard plug and play announcement mechanism whereby the Universal Plug and Play component 311 of the projection target 301 announces its presence and capabilities to the Universal Plug and Play component 305 of the projection device. Alternatively, the Universal Plug and Play component 305 of the projection device 201 may affirmatively search for and locate the Universal Plug and Play component 311 of the projection target 301.

Although Universal Plug and Play will be familiar to those of skill in the art, a brief overview is provided herein for the convenience of the reader. The reader is invited to consult published standards information for further information if desired. Universal Plug and Play refers to a standardized set of methods for device interaction. In particular, UPnP allows peer-to-peer connectivity of intelligent devices, appliances, and so on. UPnP is applicable within managed, unmanaged, and ad hoc networks. UPnP employs existing TCP/IP and Internet technologies to provide for the exchange of control information and data between networked devices. UPNP networking is designed to be independent of the particular network medium or media being used.

The UPnP control point typically exposes a set of COM (Component Object Model) interfaces through which applications may find and control the host device. Applications use device objects to retrieve information or properties pertaining to the host device. Such information can include, among other information, device hierarchy information, device properties, device manufacturer information, device model information, device display information, and services provided by the device. Note that the UPnP control point need not be a COM entity, although such is discussed herein for purposes of explication. UPnP-enabled devices can be controlled by way of the services they expose, there typically being one service for every primary function that the device can perform. Note that a complex device may be represented by some simple services in addition to other nested devices. A service typically comprises a set of state variables and a set of actions that an application may invoke to operate on one or more variables in the set of state variables. Services are identified by a service type as well as a service ID.

Once the UPnP components 305, 311 of the projection device 201 and the projection target 301 have connected, the UPnP component 305 of the projection device downloads a UPnP service document advertised by the UPnP component 311 of the projection target 301 in step 405. A service document is a computer-parsable document typically containing a description of commands that the associated device will recognize as well as perhaps some other basic device information such as proper name, number of interfaces, etc. In an embodiment of the invention, the service document comprises, in addition to other information, a description of the device resolution, color depth, a current control point, a current state, as well as brightness, contrast, and tint values. In step 407, the retrieved service document is passed to the projector control point 303 of the projection device 201. In this manner, the projector control point 303 is able to enumerate the services that the projection target 301 provides.

At this point, the projection device 201 is aware of the existence and capabilities of the projection target 301 via the UPnP exchange, and a projection session may be connected. A unique reverse terminal server connection technique is followed to create the presentation data exchange connection for the projection session. Thus, at step 409 the projector control point 303 of the projection device 201 generates a session ticket for its terminal services server 307. The session ticket is preferably generated in coordination with the Remote Desktop Protocol (RDP). RDP is a multichannel capable protocol that is an extension of the T.120 family of protocol standards. The protocol supports a plurality of virtual channels, each for exchanging a particular type of information, such as presentation data, input data and so forth. RDP maintains a stack (for the terminal services client or server) that is similar to the stack prescribed by the OSI seven-layer model. In particular, data to be transmitted from the server is processed downward through the protocol stack, sectioned, sent to an appropriate channel, encrypted if appropriate, wrapped, framed, packetized according to a network protocol, addressed, and transmitted to the client. The generated ticket presents information regarding how the projection target 301 should connect (via the terminal services client 313 of the projection target 301) to the projector control point 303 of the projection device 201, as well as in what mode to connect. For example, the connection mode may be specified as a projection mode, extended desktop mode, a mode for display of a particular application's screen information, etc. In addition, the generated ticket is given an unusually limited time out period such as, for example, ten seconds, in order to provide for a more secure connection process between the projection device 201 and the projection target 301. Note that although an embodiment of the invention is described herein by way of RDP, use of RDP is not required in every embodiment, as other technologies such as HTML may alternatively be used.

In step 411, the generated ticket is passed to the projection target 301 via its UPnP component 311 from the UPnP component 305 of the projection device 201. At this point, the ticket information can be used by the projector device point 309 to connect a terminal services session. To facilitate this, the UPnP component 311 of the projection target 301 passes the received ticket to the projector device point 309 at step 413. The projector device point 309 then passes the ticket to the terminal services client 313 at step 415. As the final step to creation of the terminal services connection, the terminal services client 313 of the projection target 301 uses the ticket in step 417 to establish a connection back to the terminal services server 307 of the projection device 201. Note that in an embodiment of the invention, this connection is timed so that it will time out if it remains inactive for longer than a predetermined period of time, such as ten minutes. In this manner, a projection device user will not be able to inadvertently monopolize the projection target, such as by walking away without closing the connection, when another user could be waiting to use the target. In step 419, with the terminal services connection having been established, the terminal services server 307 of the projection device 201 transmits presentation data such as screen data from the screen of the projection device 201 to the projection target 301 via the connection.

Note that the data transmitted at step 419 or subsequently may consist of or comprise audio and or video information. This information is preferably encoded to conserve bandwidth, and as such the codec module 315 of the projection target is used to decode the information. In an embodiment of the invention, the audio and/or video information of interest may not be played at the projection device 201 itself but rather only at the projection target 301. In this manner, copyright restrictions regarding numbers of licensed users may be adhered to when present. Similarly for text or other non-video visual information, copyright restrictions should be respected where appropriate by restricting the number of screens upon which, or users to which, the relevant information is displayed. It is also contemplated, but less desirable, to transmit audio and/or video information from the projection device 201 to the projection target 301 in unencoded form.

In step 421, the projection target 301 renders and/or plays the received information as appropriate via a display screen, speakers, etc. as needed. Certain technologies usable to implement embodiments of the invention, such as Terminal Services by MICROSOFT of Redmond, Wash., do not automatically allow display of information simultaneously on both a terminal client screen and a terminal server screen. In such cases, shadowing, such as is used in MICROSOFT Remote Assistance, may be used to provide the terminal server display.

It can be seen from the foregoing description that the terminal services session described herein actually involves a reverse terminal server model, wherein the server initiates a connection by instructing the client to connect. It is this model, among other improvements, which allows the some of the beneficial behavior described above with respect to certain embodiments of the invention.

Although the embodiments of the invention have been variously described using either a group of one or more user-associated devices, such as laptop computers, as the projection target devices, or using a dedicated device such as a conference room projector as the projection target device, it will be understood that the invention also contemplates situations wherein both one or more user-associated devices and one or more dedicated devices simultaneously serve as projection targets. For example, while a conference presentation may occur primarily via a dedicated projection device, a particular user may wish to see the presentation at his or her laptop computer due to deficiencies in eyesight, or for other reasons. Additionally, although the foregoing description has treated the projection target(s) as being somewhat distant from the projection device 201 (although generally in the same room) such is not necessary. For example, the invention can be used in one embodiment to provide dual screen functionality for the projection device 201. That is, the projection target screen may display some further portion of the desktop shown by the projection device screen. Alternatively, although less desirably, the invention may be used in one embodiment to project or receive information beyond the bounds of a physical room. For example, an authorized user in an office may operate a projection device or target, such as a desktop PC, to participate in a conference in a nearby room.

According to an embodiment of the invention, the projector control point 303 of the projection device 201 uses additional information available from the projection device 201 or from a network to which the projection device 201 is attached or attachable to further refine its operation. For example, the projector control point 303 may access the calendar of the user of the projection device 201 to select a projection target device from a number of possible candidate devices. For example, the OUTLOOK brand mail utility by MICROSOFT can maintain a user's schedule including information such as the room in which a scheduled conference is to be held. The projector control point 303 of the projection device 201 can use this information to select which of a number of nearby projection devices is the appropriate one with which to connect at the scheduled time. In particular, the projection device associated with the conference room in which the conference is scheduled should be selected, or presented to the user as a probable best selection.

All of the references cited herein, including patents, patent applications, and publications, are hereby incorporated in their entireties by reference. That is, each and every part of every such reference is considered to be part of this disclosure, and therefore no part of any such reference is excluded by this statement or by any other statement in this disclosure from being a part of this disclosure.

In view of the many possible embodiments to which the principles of this invention may be applied, it should be recognized that the embodiments described herein with respect to the drawing figures are meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Furthermore, although network connections are illustrated herein as lines, no limitation should thereby be imparted to the invention. Except where otherwise noted, network connections may be circuit-switched, packet-switched, or otherwise, and may be transient or permanent, hard-wired or wireless, operating via any suitable protocol. Moreover, the exact values such as for time periods given in the above description are exemplary only, and may be varied without departing from the scope of the invention. Therefore, the invention as described herein contemplates all such embodiments as may come within the scope of the following claims and equivalents thereof.

We claim:

1. A method of presenting data from a first computing device on a projector comprising:
automatically becoming aware of the presence of the projector and a set of capabilities of the projector;
sending to the projector a request for the projector to open a data exchange session back to the first computing device;
receiving from the projector a connection request, whereby acceptance of the connection request opens a data exchange connection between the first computing device and the projector; and
sending data from the first computing device to the projector via the data exchange connection, whereby the data can be manifested by the projector.

2. The method according to claim 1 wherein the first computing device is a computing device of a type selected from the group consisting of laptop computer, desktop computer, and handheld computing device.

3. The method according to claim 2, wherein the data exchange connection comprises a link over a network including at least one wireless link.

4. The method according to claim 3, wherein the computing device comprises a wireless interface to the at least one wireless link.

5. The method according to claim 1, wherein the projector is a computing device.

6. The method according to claim 1, further comprising:
automatically becoming aware of the presence of a second computing device;
sending to the second computing device a request for the second computing device to open a data exchange session back to the first computing device;
receiving from the second computing device a connection request, whereby acceptance of the connection request opens a data exchange connection between the first computing device and the second computing device; and
sending data from the first computing device to the second computing device via the data exchange connection between the first computing device and the second computing device, whereby the second computing device can manifest the data.

7. The method according to claim 6, wherein the second computing device is a laptop computer.

8. The method according to claim 1, wherein sending data from the first computing device to the projector comprises sending information of at least one type selected from the group of types consisting of graphical information, video information, audio information, animated information, and textual information.

9. The method according to claim 1, wherein sending data from the first computing device to the projector comprises sending information consisting of audio information.

10. The method according to claim 1 wherein automatically becoming aware of the presence of the projector and a set of capabilities of the projector comprises utilizing the Universal Plug and Play protocol to identify the projector.

11. The method according to claim 1 wherein the data exchange connection between the first computing device and the projector comprises a connection between a terminal services client and a terminal services server.

12. The method according to claim 11, wherein the terminal services client is hosted at the projector and the terminal services server is hosted at the first computing device.

13. The method according to claim 1, further comprising displaying the data on a visual display of the first computing device.

14. The method according to claim 1, further comprising passing control from the first computing device to a second computing device, whereby the second computing device may send data to the projector to be manifested by the projector.

15. The method according to claim 1, further comprising preventing a second computing device from sending to the projector data to be manifested.

16. A system for projecting displayable data from a computing device to a projector comprising:
a projection controller hosted by the computing device;
a discovery tool communicably linked with the projection controller for automatically becoming aware of the projector; and
a data exchange session server communicably linked with the projection controller for accepting and conducting a data exchange session between the computing device and the projector, wherein the displayable data is transmitted from the computing device to the projector.

17. The system according to claim 16 wherein the computing device is a computing device of a type selected from the group consisting of laptop computer, desktop computer, and handheld computing device.

18. The system according to claim 16, wherein the data exchange session employs a link over a network including at least one wireless link.

19. The system according to claim 16, wherein the displayable data comprises information of at least one type selected from the group of types consisting of graphical information, video information, audio information, animated information, and textual information.

20. The system according to claim 16, wherein the discovery tool operates according to the Universal Plug and Play protocol.

21. The system according to claim 16, wherein the data exchange session server comprises a terminal services server.

22. A projection system having a projector for receiving data from a computing device for exhibition comprising:
a projector control point hosted by the projector;
a projector locator communicably linked with the projector control point for advertising the presence of the projector; and
a data exchange session client communicably linked with the projector control point for establishing and conducting a data exchange session between the computing device and the projector.

23. The projection system according to claim 22, wherein the data exchange session client is a terminal services session client communicably linked to a terminal services session server hosted by the computing device.

24. The projection system according to claim 22 wherein the projector is a device of a type selected from the group consisting of laptop computer, desktop computer, conference room projector, and hand-held device.

25. The projection system according to claim 22, wherein the projector is linked via a wired link to a network infrastructure to which the computing device is linked via a wireless link.

26. The projection system according to claim 22, wherein the projector and the computing device are wirelessly linked to a common network infrastructure.

27. The projection system according to claim 22, wherein the projector and the computing device are wirelessly linked via an ad hoc wireless network.

28. The projection system according to claim 22, wherein the data for exhibition comprises information of at least one type selected from the group of types consisting of graphical information, video information, audio information, animated information, and textual information.

29. The projection system according to claim 22, wherein the projector locator operates in accordance with the Universal Plug and Play protocol to advertise the presence and capabilities of the projector.

30. A method of replicating screen data from a computing device to a projector comprising:
receiving an indication from a projection target locator resident on the computing device of the presence of the projector;
causing the projection target locator to transmit a data exchange connection invitation to the projector;
receiving a connection request responsive to the transmitted connection invitation, and opening a data exchange connection between the first computing device and the projector in response to the connection request; and
sending the screen data from the first computing device to the projector via the data exchange connection, whereby the screen data is displayed by the projector.

31. An apparatus for remotely presenting the screen data of a computing device comprising:
means for discovering a remote display device;
means for inviting the remote display device to initiate a communication session with the computing device;
means for accepting a communication session request from the remote display device, thereby opening a communication session; and
means for transferring the screen data from the computing device to the remote display device via the communication session.

32. The apparatus according to claim 31, wherein the means for discovering a remote display device executes discovery in accordance with the Universal Plug and Play protocol.

33. The apparatus according to claim 31, wherein the means for inviting the remote display device to initiate a communication session with the computing device comprises means for generating a session ticket to be used to initiate the communication session.

34. A projection system having a large venue display device for receiving display data for exhibition from a computing device comprising:
a control point hosted by the display device;
a locator communicably linked with the display device control point for advertising the presence of the display device; and
a data exchange session client communicably linked with the display device control point for establishing and conducting a data exchange session between the computing device and the display device.

35. A computer-readable medium having thereon computer-executable instructions for performing a method of presenting data from a computing device on a remote projector, the method comprising:
automatically ascertaining the presence of the remote projector and a set of capabilities of the remote projector;
sending to the remote projector a request for the remote projector to open a data exchange session back to the computing device;
receiving from the remote projector a connection request, whereby acceptance of the connection request opens a data exchange connection between the computing device and the remote projector; and
sending data from the computing device to the remote projector via the data exchange connection, whereby the data can be manifested by the remote projector.

36. The computer-readable medium according to claim 35, wherein the data exchange connection comprises a network connection having at least one wireless link.

37. A computer-readable medium having thereon computer-executable instructions for performing a method of presenting data from a computing device on a remote projector, the method comprising:
transmitting from the remote projector to the computing device an indication of capabilities of the remote projector;
receiving at the remote projector from the computing device a request for the remote projector to open a data exchange session to the computing device;
sending from the remote projector to the computing device a connection request, whereby acceptance of the connection request by the computing device opens a data exchange connection between the computing device and the remote projector;
receiving data at the remote projector from the computing device via the data exchange connection; and
causing the received data to be manifested in a human-perceivable manner.
